(19) United States
(12) Patent Application Publication
(10) Pub. No.: US 2012/0118919 A1
(43) Pub. Date: May 17, 2012

(54) FEED BAG CONSTRUCTION

(75) Inventor: Joseph Cianciolo, Hudson, MA (US)

(73) Assignee: Millipore Corporation, Billerica, MA (US)

(21) Appl. No.: 13/297,929

(22) Filed: Nov. 16, 2011

Related U.S. Application Data
(60) Provisional application No. 61/414,610, filed on Nov. 17, 2010.

(51) Int. Cl. G01F 11/20

(52) U.S. Cl. 222/413

(57) ABSTRACT

A bag construction is provided comprising a bag, a first conduit sealed to the feed bag, an impeller device secured within the bag and extending from the first conduit in the bag to a second end and a one piece cap that is removably mounted on the first conduit. Optionally, the bag has a second conduit sealed to the interior of the bag for supplying wash reagent such as gas or a liquid to the bag. The impeller device is driven to cause all material in the bag to flow out the first conduit.

### CROSS-REFERENCE TO RELATED APPLICATIONS

The present application claims the benefit of priority of U.S. Provisional Patent Application No. 61/414,610, filed on Nov. 17, 2010, the entire content of which is incorporated by reference herein in its entirety.

### BACKGROUND OF THE INVENTION

This invention relates to a sterile conduit connection apparatus and more particularly to a feed-bag structure, that includes the sterile conduit connection apparatus.

Presently, a wide variety of solid compositions including cell culture supplements, buffers, media or the like are utilized in the biotechnology industry in producing and purifying biological products such as protein. These biological products are required to be produced under conditions to avoid product contamination. In many cases, the reagents are expensive and reagent losses should be minimized or prevented.

Presently, feed-bags containing the product producing reagents are provided with a conduit for filling and emptying the feed-bag of the reagent. This conduit is provided with a valve to permit or prevent passage of reagent through the conduit. The feed-bag conduit has a flange extending about the periphery of the conduit opening. A cap shaped to fit over the conduit opening to prevent outside atmosphere from entering the bag and for minimizing loss of reagent also is provided. A flexible gasket is positioned between the conduit flange and the cap. The cap also is provided with a flange that extends about its periphery. The flanges then are pressed together with the gasket between them by a clamp that extends over both flanges. The clamp has a pivot connection, which permits it to open and close about the flanges. This presently available conduit seal structure is undesirable since it is costly due to the multiple components and it requires two persons to effect the seal, one to activate the clamp and a second to retain the cap and conduit.

Additionally, the present bags do not allow for the easy metering or premixing of different dry and or wet components into the vat or bioreactor or other such vessel. Presently available components require the closing of a valve that often needs two people to operate and which is difficult to close against the movement of the materials inside the bag.

Accordingly, it would be desirable to provide a feed-bag structure that allows for the metering of components into a vessel, and/or which allows for the premixing of different components (wet or dry) before entering the vessel. In addition, it would be desirable to provide a feed-bag structure that permits washing out of all of the reagent in the bag.

### SUMMARY OF THE INVENTION

In accordance with this invention, a feed bag construction is provided for delivering solid or liquid reagents to a desired point of use such as to a cell culture medium or the like. The feed bag construction includes a bag sized to store a desired amount of reagent, a first conduit for filling or emptying the bag, an auger positioned within the bag and having an end located at the first conduit for controlling passage of reagent through the conduit.

Optionally, a second conduit for introducing a liquid into the bag can be used. This may be a wash liquid used to remove, by rinsing, residual reagent from the bag through the first conduit or it may be a component of the materials being added so as to either dissolve or make the dry material if used into a paste or dough.

The second conduit comprises a connector arrangement for connection to a wash liquid source. In one aspect of this invention, the second conduit has multiple outlets for washing the interior of the bag to remove residual reagent there from is provided.

In another aspect of the present invention, the second conduit has a plurality of port sprayers for delivering the wash liquid to the interior of the bag. The port sprayers direct wash liquid to the top interior surface of the bag and to then direct wash liquid over the entire length of the bag interior and out through the first conduit.

In a further embodiment, a trough is built into the bag below the auger such that all material in the bag falls or moves into the trough and then out the opening in the bag via the auger and/or gravity or a liquid wash.

The bag and first conduit are joined together in any conventional manner such as by heat sealing or with a clamp or the like. A cap is preferably provided over the first conduit for retaining reagent within the bag such as when transporting the feed bag construction to a desired point of use. The cap is one piece thus providing a cost advantage and use advantage over the conduit closing means of the prior art. The one piece cap of this invention encloses a flange at the end of the conduit and provides a means for sealing the bag

### BRIEF DESCRIPTION OF THE DRAWINGS

FIG. 1 is a front exploded partial cross sectional of the feed bag construction of this invention.

FIGS. 2A and B are cross sectional views of the cap and first conduit utilized in the feed bag construction of this invention.

FIG. 3 shows a container or bin into which a bag according to FIGS. 1, 2A-2B can be used for use

FIG. 4 shows a bag of the present invention of FIGS. 1 and 2A-B in a container of the present invention according to FIG. 3 in cross sectional view.

FIG. 5 shows a bag of the present invention in a container of the present invention in a front end onward view.

FIG. 6 shows another embodiment of the bag and container of the present invention in cross sectional view.

FIG. 7A shows another embodiment of the bag of the present invention in cross sectional view and FIGS. 7B and 7C show another embodiment of the bag of the present invention in front on cross sectional view.

### DESCRIPTION OF SPECIFIC EMBODIMENTS

The feed bag construction of this invention is useful for storing and delivering liquid or solid reagents such as powder or tablets. Representative suitable reagents include cell culture supplements, buffers reagents, alkaline reagents, acidic reagents or the like. The feed bag construction of this invention permits opening or closing a conduit that can be an inlet or outlet utilized by one person and without the use of a clamping mechanism. The feed bag construction of this invention is disposable.

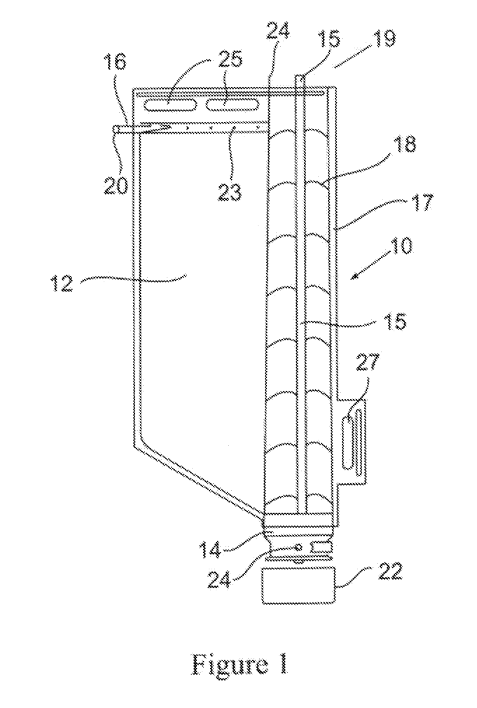

Referring to FIG. 1 the feed bag construction 10 of this invention is shown. The feed bag construction 10 can be of style as taught by U.S. Ser. No. 12/818,754 filed Jun. 18, 2010 although any feed bag design can be used as desired so long as it will facilitate the introduction of a feed system into the bag.

The feed bag construction 10 includes a bag 12, a first conduit 14 sealed to the bag 10 and optionally a second conduit 16. The bag 12 is formed of a flexible polymeric composition such as silicone, polyethylene, polypropylene, PTFE resin, C-Flex® resin or the like and laminates and co-extrusions of multi-layers of these materials such as Pureflex™ films available from Millipore Corporation and HyQ® films available from Thermo Fisher Scientific Inc. The first conduit 14 is utilized to empty the bag 12 with a desired reagent. It may also be used if desired to help fill the bag 12 although other means such as having an open second end which after filling is sealed or a separate fill port (not shown) may be used. An auger or other type of rotary impeller device 17 having a shaft 15 and a series of blades 18 is positioned within the bag 12 with a first end of the auger 17 being rotatably secured to or in the first conduit 14 and a second end 19 of the auger 17 extending to and preferably through a second end of the bag 12 via a holder in a rotatable and sealed manner such as by a sealed bearing journal or one or a series of gaskets or O-rings between the shaft 15 of the second end 19 and its holder. In another embodiment, the second end of the shaft it rotatably secured in its holder within the bag and contains a magnetic or magnetable material such as iron or a permanent magnet. That magnet is driven by a remote magnetic device such as a magnetic coupling secured to a motor to rotate the shaft without penetrating the bag itself with a journal or the like.

The bag 12 may be provided with openings 25 to permit hanging the bag 12 during use. The bag 12 also may be provided with a handle 27, which permits carrying the feed bag construction 10. While shown as being on the side of the bag with the auger 17, it can equally be mounted on the other side of the bag 12 if desired.

In use, a cap 22 is removed from the first conduit 14 such as by unscrewing the cap. The cap can be removably connected to the first conduit 14 by any conventional means such as by being snap fitted thereto or a frangible bridge such as a tear away safety closure (not shown). Other devices for temporarily sealing the outlet or first conduit of the bag may be used such as metal or plastic foils or films heat bonded or adhered to the face of the outlet/first conduit, a tear away structure or a simple closed end formed by sealing the film to itself in front of the outlet/first conduit that can be opened by sliting or cutting the sealed portion away.

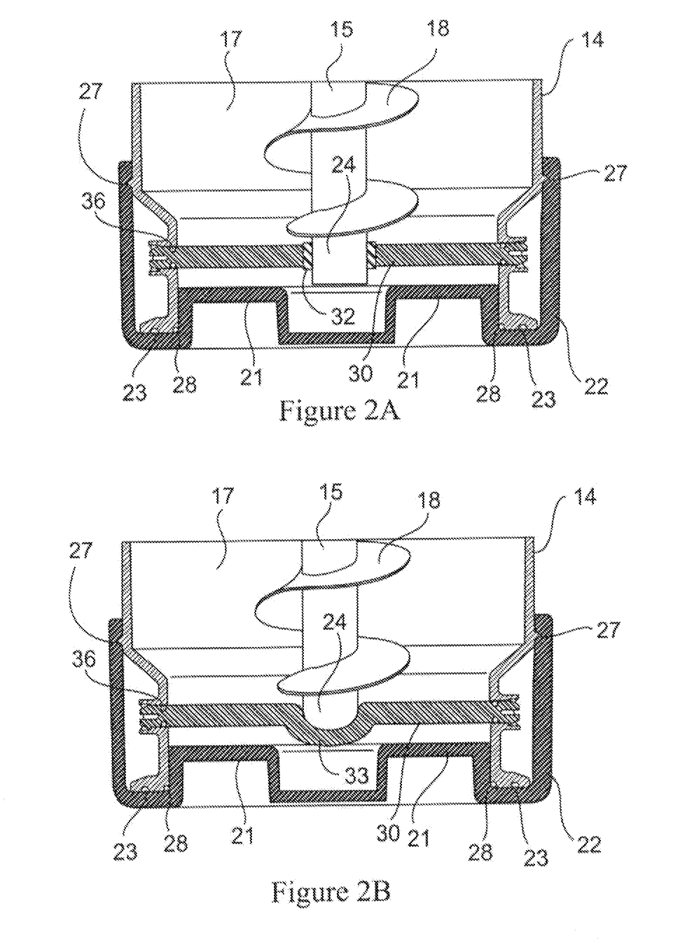

The cap 22 is provided to fit over the first conduit 14 thereby to prevent leakage through conduit 14. Referring to FIG. 2A, the cap 22 has threads 27, which permit screwing the cap 22 onto conduit 14. Other devices for retaining the cap 22 to the first conduit 14 such as snap fits, tear-away devices and the like can also be used in lieu of the threads as shown. The shaft 15 of the auger 17 is retained in the first conduit 14 by a rod 30 that may contain a journal 32 which allows the shaft 15 to rotate but remain fixed in place within the bag 12. The journal 32 may contain bearings or as shown one or more gaskets. Alternatively, as shown in FIG. 2B the first end 24 of the shaft 15 may simply fit into a recess 33. Preferably a slick surface is present on the journal, recess and/or first end to reduce or eliminate any friction during rotation of the shaft 15. Additionally, it is preferred that the first end 24 be rounded as shown at 24B of FIG. 2B to further reduce any friction between the parts. O-ring 28 mounted in cap 22 seals the end of conduit 14 to cap 22. The cap 22 may be provided with one or more raised sections 21. The raised sections 21 prevent activation of the auger 17 when the cap 22 is in position on the first conduit 14. The one piece cap encloses the end of the first conduit 14, the auger 17 and can be removed from or attached to the first conduit 14 by one person. The O ring 28 can be molded to the end of the first conduit 14, the inside surface of the cap 28 or can be a separate piece. The end of the first conduit 14 can be provided with an optional groove 23, which is adapted to house an additional gasket. The rod 30 maybe a separate piece as shown in the Figures or use O-rings 36 to liquid tightly secure it in place in the first conduit or it maybe molded as part of the first conduit.

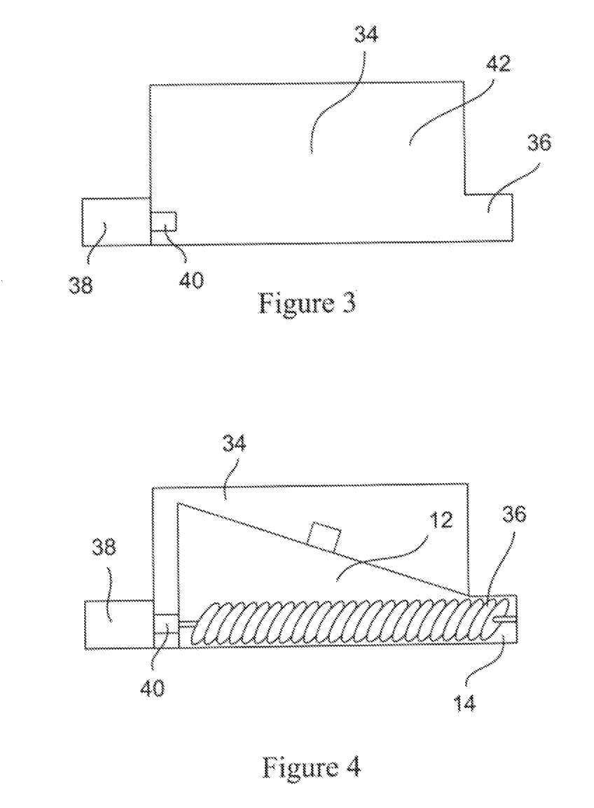

FIG. 3 shows a container or bin 34 into which a bag according to FIGS. 1-2B can be used for use. The container has a first opening 36 into which the first conduit of the bag 12 is inserted. it also has a drive means 38 such as a motor, an electric drill (corded or battery operated) a hand crank or handle, a pulley connected by a belt to a drive motor or like that connects the second end of the shaft via a junction 40 in order to turn the shaft 15 when desired. The container 34 has a compartment 42 for holding the bag 12 and its contents during use. The junction can be any type of device that helps connect a shaft to a drive means. For example it may be a recess or socket, such as a square or hexagonal shape, that fits to a similar shape of the second end of the shaft 15 to mate with it and turn it with little or no loss in translation between them. It may be a round recess such as a flexible rubber cup that connects to ant protrusion of the second end of the shaft. It may be physically connected to the second end of the shaft such as by a screw thread or it may contain a hole through it and the second end of the shaft in which a cotter pin or screw or nut and bolt may be secured to physically hold the two elements together. Other similar means may also be used.

FIG. 4 shows the bag 12 in the container 34. As shown the bag 12 is housed within the compartment 42 of the container 34 with the first conduit 14 in or extending from the opening 36 of the container 34 as desired. The second end of the shaft 15 is attached to the drive means 38 via the junction 40. The first conduit is opened by removing the cap 22 and the drive means is engaged to cause the auger to rotate and feed the bag's material out of the opening 36.

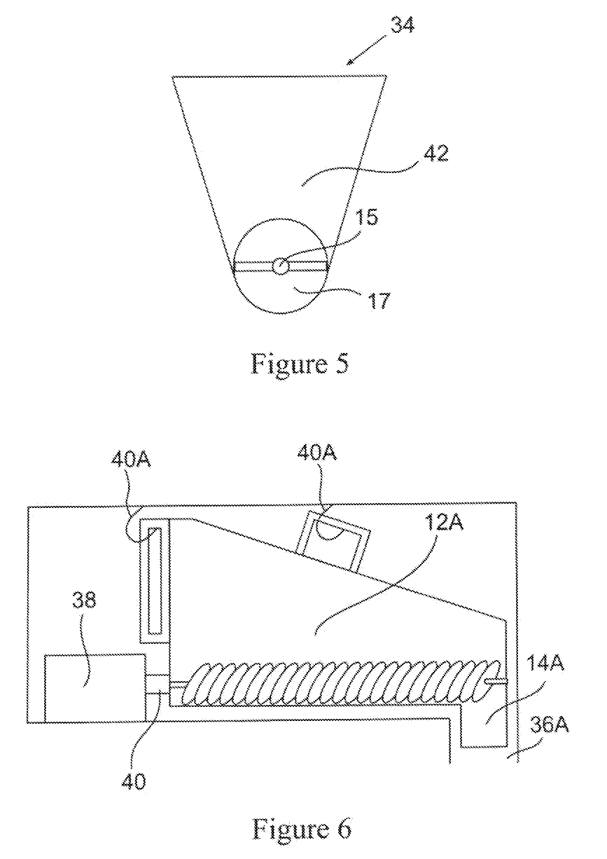

FIG. 5 shows the container 34 and bag front end onward. As shown the compartment and if desired the bag itself may have a tapered sidewall profile to further enhance the flow of material to the auger for movement out of the bag 12.

FIG. 6 shows another bag 12A and container 34A embodiment. In this version the bag's first conduit is at a right angle to the length of the bag 12 and the first opening 36A of the container 34A is likewise configured. The first end of the auger shaft 15 may be held by a portion of the first conduit that extends upward from the opening or it may be secured to a separate piece of rigid material such as plastic (not shown).

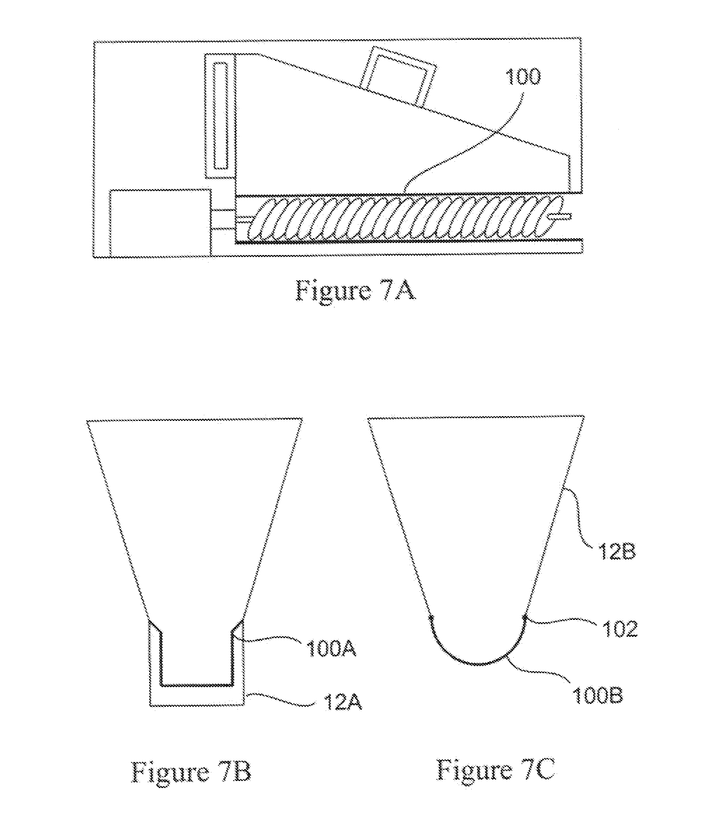

In a further embodiment as shown in FIGS. 7A-7B, the bag has a trough 100 formed below and adjacent the auger 17. The trough ensures the material in the bag 12 exits the bag as desired. Additionally, it allows for the mixing of different materials or liquids/solids to occur in an organized manner. As shown in FIG. 7A, the trough 100A is contained inside the bag and sealed to the inner surfaces of the bag 12A. Alternatively, as shown in FIG. 7B, the trough 100B becomes the bag bottom and the bag 12B is sealed to a top or side of the trough 100B as indicated by seal 102. Preferably, the trough. 100, 100A or 100B is made of a material compatible with the bag material so it may simply be heat sealed or sonically welded to the bag 12 to form a liquid and solid tight seal. Such materials can be a thicker piece of thermoplastic such as polyethylene or polypropylene than the film of the bag itself. It can be rigid and molded to the trough shape. Alternatively, it could be heat formed or vacuformed to the trough shape or simply bent or flexed and sealed to the film of the bag. As shown, the trough is in the form of a hemisphere (FIG. 7B) although other shapes such as a V (FIG. 7A), or a square or any other desired cross-sectional shape, be easily used so long as they provide a similar function.

Upon emptying the bag 12, an optional feature is provide wash liquid to the second conduit 16 through connector 20 and passed through outlets (not shown) thereby to remove stored reagent from the bag.

The second conduit 16 is sealed to the bag 12 and in a preferred embodiment has a plurality of outlets. The conduit 16 has a connector 20 adapted to be connected to a source of wash liquid such as sterile water. Alternatively, it may also be connected to a sterile connector system such as a Lynx® STS connector so that the bag can be presterilized in a sealed manner and then connected to a fluid source later on and still maintain its sterility inside the bag 12. The other end 21 of the conduit 16 is preferably sealed or contains one or more outlets 23. The end maybe sealed with a cap or plug (not shown) when the conduit is in the form of a preformed tube. It may also be sealed to itself or crimped shut.

The conduit 16 may be a tube made from commonly used materials such as silicone, polyethylene, polypropylene, C-Flex® material and the like.

Alternatively, it may be made of the same material as the bag and it may be formed if desired by a portion of the film that forms the bag. For example, it may be a separate piece of film that is folded/rolled on itself. One end of the folded film is sealed such as onto itself to prevent flow. The other end is sealed to the connector in a liquid tight manner such as by adhesives, heat bonding, ultrasonic welding or clamps or cable ties. The connector 20/conduit 16 are then attached to the top seam or side of the bag 12 such as by adhesives, heat bonding, ultrasonic welding. In another embodiment, the conduit 16 is a portion of the film forming one side of the bag 12 and it is folded back on itself, sealed and attached as described above.

In a further embodiment the conduit is formed of a porous material such as a non-woven plastic paper suchs Typar® or Tyvek® paper, folded/rolled to form the conduit 16 and sealed and attached to the bag 12 in a manner similar to that described above.

The conduit 16 preferably has a series of outlets 23 as shown along the length of the conduit to distribute the flow of wash liquid across the width of the bag 12. Preferably the flow is even across the width of the bag 12 up to the space occupied by the auger 17. The outlets size may vary depending upon the size of the stream/rate of flow that is desired. The outlet size should be large enough to ensure that there is good washing of the material contained within the bag 12 during the washing procedure with the minimal amount of fluid necessary. If desired the outlets 18 may vary in size along the length of the conduit 16 such as from smaller near the connector 20 to larger near the other end 19 of the conduit 16 so as to ensure that liquid is evenly distributed across the length of the conduit 16 as flow and pressure drops along the length of the conduit 16.

The outlets 18 may also be arranged in a single row or multiple rows along the length of the conduit 16 as desired. In a single row embodiment, the outlets 18 may all be uniformly directed downward into the bag 12. Alternatively, they may alternate in series such that a first outlet 18 is directed downwardly toward a first side of the bag 12 and a second outlet is directed downwardly and toward the second side of the bag. Another embodiment would have a third outlet 18 directed directly down into the bag 12. In a multiple row embodiment, one row of outlets 18 would be directed downwardly toward a first side of the bag 12 and a second row of outlets 18 outlet is directed downwardly and toward the second side of the bag. Another embodiment would have a third row of outlets 18 directed directly down into the bag 12.

The conduit 16 either directly or through a sterile connector described above is connected to a source of wash liquid such as sterile water, a sterile buffer solution such as phosphate buffer and the like or whatever other liquid, such as a solvent, is used with the powder.

While the above embodiments show the auger positioned closer to one side tan the other it can be located at a more central position especially where the bag and auger are hung in a vertical orientation with the first conduit being in the lowermost position of the bag . Other similar arrangements may also be used with the present invention.

The device of the present invention can be formed in many ways. One can manufacture the first conduit, shaft and auger and blades from a suitable plastic material that is sufficiently rigid to provide a self supporting structure and which is capable of moving the material in the bag as desired. A bag formed of one or more pieces of plastic film is cut and sealed such as by heat bonding the itself and the first conduit and a second portion of the auger adjacent the second end. The auger is retained in place by a connection described above such as a journal or recess to the first conduit and the second end 19 again by a journal or like device. Preferably the first conduit is sealed off as made and a portion of the film is left unsealed so that the material can be placed into the bag. The film is then sealed at that location. If desired the bag can be sterilized such as by gamma or beta irradiation in its sealed condition.

The bag can be hung above a vat or bioreactor or other vessel into which the material of the bag is to be introduced. Alterantively, it may be placed in a dedicated container 34 as described above. The first conduit is opened the drive means 38 engages the auger 17 via the connector 40 to cause the material to move out of the bag and into the adjacent vessel. If desired liquid or another material to be blended with that of the bag may be entered into the bag via the optional second conduit. Liquid or air may also or alternatively be introduced through the second conduit to ensure that all material is removed from the bag.

The auger, first conduit and other rigid pieces of the device are preferably made of plastic such as as polyolefins, especially polyethylene and polypropylene, homopolymers or copolymers, and ethylene vinyl acetate (EVA) copolymers; polycarbonates; styrenes; PTFE resin; thermoplastic perfluorinated polymers such PFA; nylons and other polyamides; PET and blends of any of the above, epoxies, polyurethanes, various composites such as fiberglass reinforced epoxy, carbon or graphite composites, other thermosetting plastics and the like. Alternatively, the auger, conduit and/or trough may be made of a metal such as aluminum or stainless steel if desired.

What is claimed:

1. A feed bag construction comprising:
a bag having a top, a bottom, a first end and a second end all connected to each other,
a first conduit sealed to the first end of the bag,
an impeller device comprised of a shaft and one or more blades mounted to the shaft,
a first end of the shaft being rotatably secured at the first end of the bag adjacent the first conduit,
a second end of the shaft and at the opposite end of the shaft from the first end being rotatably secured to a holder formed at a second end of the bag, and
a cap positioned outside said first conduit for opening or closing the first conduit.

2. The construction of claim 1 further comprising a second conduit located at a position remote from the first end of the bag for introducing wash liquid or gas into the bag to remove residual reagent from the bag through the first conduit, the second conduit extending substantially across the length of the bag, the second conduit having a connector positioned outside the bag on one side of the second conduit and a seal adjacent another side of the second conduit, the second conduit having multiple outlets spaced along its length.

3. The construction of claim 1 wherein the impeller device is an auger.

4. The construction of claim 1 wherein the cap covering the first conduit portion extends beyond the first end of the bag.

5. The construction of claim 1 wherein the second end of the impeller device has a piece selected from the group consisting of a magnet and a magnetizable material and a magnetic drive coupling outside of the bag is used to rotate the impeller device when desired.

6. The construction of claim 1 wherein the second end of the impeller device extends through the second of the bag via the holder and contains a connection on the second end of the shall beyond the bag interior capable of mating with a drive means for the shaft

7. The construction of claim 1 wherein the bag and first conduit are joined together by a means selected from the group consisting of heat sealing and a clamp.

8. The construction of claim 1 further comprising a trough located below the impeller device.

9. The construction of claim 1 further comprising a trough located below the impeller device and sealed to an inner surface of the bag.

10. The construction of claim 1 further comprising a trough located below the impeller device with the bag sealed to a top or side of the trough such that the trough forms the bottom of the bag.
